(19) United States
(12) Patent Application Publication
(10) Pub. No.: US 2009/0199607 A1
(43) Pub. Date: Aug. 13, 2009

(54) Tubular lock structure

(76) Inventor: Tzong-Chyuan Huang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,469

(22) Filed: Feb. 7, 2008

(51) Int. Cl. E05B 27/00

(52) U.S. Cl. 70/491

(57) ABSTRACT

A lock includes a shell, an annular holding member, and a bead holder; the shell has three gaps around its lock hole; the annular member is held in the shell, and has a central shaft, three gaps, and several holes each holding a pine therein; the bead holder is positioned around one end of the shaft in the shell, and has cavities around its middle hole; long beads are held in the cavities respectively, and biased towards the holes of the annular holding member with springs to engage the annular member; a key is used with the lock, which key has three outer bar portions; when the key is inserted in the lock hole, and pressed inwards, it will force the pins to push the beads, and its bar portions will be received in the gaps of the annular member; thus, the annular member can be turned with the key.

### BACKGROUND OF THE INVENTION

1. Field of the Invention

The present invention relates to a tubular lock, more particularly one, which has at least two passage gaps instead of only one to allow corresponding bar portions of a key to pass through; thus, the user can certainly hold the key in the correct orientation in relation to the tubular lock when pressing the key into the lock; consequently, the key can be smoothly operated to move the lock between a locking configuration and an open one, without the risk of the key causing damage to the lock.

2. Brief Description of the Prior Art

A wide variety of locks are available for helping to prevent thievery, e.g. door locks, combination locks, and cable locks And, the industry have recently developed electromagnetic locks, chip locks, and voice-controlled locks, which are more advanced than conventional locks, and can't be easily open by unauthorized persons. Nevertheless, key locks are still the most popular because they can prevent thievery effectively, and are relatively inexpensive.

A currently available tubular lock consists of a shell, a central locking shaft in the shell, and a bead holder, which is positioned around one end of the central shaft, and fixedly held in the shell. The central shaft has an annular holding member joined thereon, which has several holding holes around the central shaft. And, long beads are received in the holding holes of the annular holding member respectively. The annular holding member further has an annular recess around an outer end portion of each of the holding holes thereof. The bead holder has several holding holes around its middle hole receiving the central shaft, and a long bead and spring combination is received in each of the holding holes of the bead holder so that the long beads are normally biased into the holding holes of the annular holding member by the springs, thus preventing the central shaft and the annular holding member from turning. The outer end portions of the holding holes of the annular holding member annular have a greater diameter than the inner end portions because of the existence of the annular recesses around them; therefore, the long beads of the bead holder can stop the annular holding member and the central shaft from turning to the unlocking position even if their axes aren't co-linear with the axes of the corresponding holding holes of the annular holding member.

Another currently available tubular lock consists of a shell, an annular holding member in the shell, a central shaft sticking from two ends of the annular holding member, and a fixed bead holder.

The shell has a partially blocked end, which defines a central lock hole; the partially blocked end has an inner annular protrusion having a passage gap adjoining the central lock hole. The annular holding member has a receiving gap, and several pin holding holes around the central shaft; a first end of the central shaft is held in the central lock hole of the shell. Furthermore, pins are held in the pin holding holes of the annular holding member respectively.

The fixed bead holder is positioned around a second end of the central shaft in the shell, and has several bead holding cavities around a middle hole thereof to face the pin holding holes of the annular holding member. Each of the bead holding cavities holds a long bead and spring combination so that the long beads are normally biased into the pin holding holes of the annular holding member by the elastic elements, thus stopping the annular holding member and the central shaft from turning.

The central shaft and the annular holding member of the lock can be turned between a locking position and an unlocking one with a key, which has an outer bar portion; after the key has been pressed into the tubular lock with its bar portion being passed through the passage gap of the shell and into the receiving gap of the annular holding member, the key will make the pins to force the long beads to move out of the pin holding holes of the annular holding member; thus, the long beads no longer fix the annular holding member, and the central shaft and the annular holding member can be turned by means of the key.

Furthermore, the central shaft has a groove on an outer side, and each of the shell and the bead holder has a fixing hole. And, a fixing pin is passed through the fixing holes of the shell and the bead holder and pressed against the groove of the central shaft. Therefore, the tubular lock has a low manufacturing cost, and is easy to assemble.

However, such a tubular lock is found to have the following drawbacks:

1. Because the annular holding member has only one receiving gap, force can't be uniformly applied to the annular holding member when the key is used to turn the annular holding member and the central shaft. Consequently, the annular holding member can't be turned smoothly to change the lock between the locking configuration and the opened one.

2. Because the annular holding member has only one receiving gap, the various pin, long bead and spring combinations can't be subjected to the same amount of force or move the same distance after the key is pressed into the lock. Consequently, it is possible for some of the long beads to fail to completely move out of the pin holding holes, and cause the annular holding member to get damaged.

3. Because there is single passage gap on the shell, and single receiving gap on the annular holding member as well as single bar portion on the key, the key can be easily inserted in the tubular lock to engage the annular holding member at the bar portion even if it isn't held in such a position that its axis is on the axis of the lock hole. Therefore, it is possible for the key and the tubular lock to cause damage to each other when the key is being operated.

Therefore, it is a main object of the present invention to provide an improvement on a tubular lock structure to overcome the above problems.

### SUMMARY OF THE INVENTION

A tubular lock according to an embodiment of the present invention consists of a shell, an annular holding member, and a bead holder. The shell has a first open end, and a second partially blocked end with a central lock hole. The shell has three passage gaps around the central lock hole.

The annular holding member is held in the shell, and has a central shaft sticking from it, and three receiving gaps. The annular holding member has several pin holding holes around the central shaft. One end of the central shaft is held in the lock hole of the shell while pins are held in the pin holding holes respectively.

The bead holder is positioned around the other end of the central shaft in the shell. The bead holder has several bead holding cavities around a middle hole to face the pin holding holes of the annular holding member. Long beads are held in the bead holding cavities of the bead holder respectively, and biased towards the pin holding holes by means of springs so as to engage the annular holding member.

The central shaft on the annular holding member can be turned between a locking position and an unlocking one with a key, which has three bar portions on an outer side; when the key is inserted in the key hole, and pressed inwards, the key will force the pins to push the long beads, and the bar portions of the key will be received in the receiving gaps of the annular holding member; thus, the long beads are moved out of the pin holding holes, and the annular holding member is free to turn.

Because the number of the receiving gaps is three, all of the pin, long bead and springs combinations will be subjected to the same amount of force to move the same distance when the key is being operated. Therefore, there won't be the risk of some of the long beads being not completely disengaged from the annular holding member after the key has been pressed into the tubular lock. Consequently, the annular holding member won't wear or get damaged. Furthermore, when the key is being pressed into the tubular lock, it has to be held in such a position that its axis is on the axis of the lock hole, otherwise its bar portions can't be received in the receiving gaps. Therefore, there can't be the risk of the key and the tubular lock causing each other to wear and get damaged when the key is being used.

### BRIEF DESCRIPTION OF THE DRAWINGS

The present invention will be better understood by referring to the accompanying drawings, wherein:

FIG. 1 is a perspective view of the present invention,

FIG. 2 is an exploded perspective view of the present invention,

FIG. 3 is a sectional view of the present invention,

FIG. 4 is a front sectional view of the present invention, taken when the key is in the lock hole of the shell, and

FIG. 5 is a lateral sectional view of the present invention, taken when the key is in the lock hole of the shell.

### DETAILED DESCRIPTION OF THE PREFERRED EMBODIMENTS

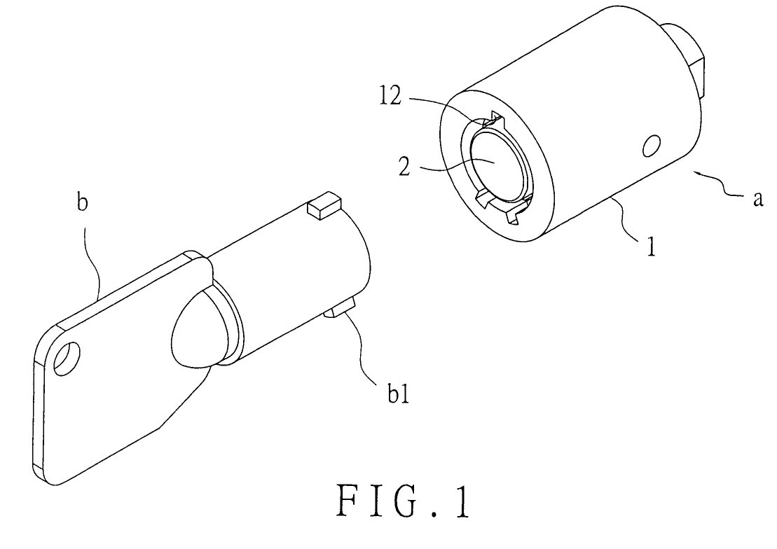

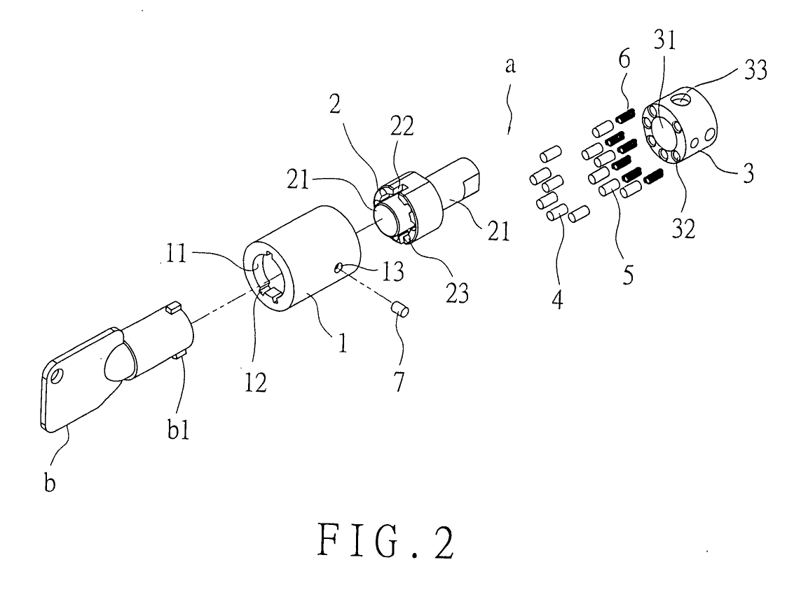

Referring to FIGS. 1 and 2, a preferred embodiment of a tubular lock structure of the present invention includes a tubular lock (a), and a key (b). The tubular lock (a) consists of a shell 1, an annular holding member 2, a bead holder 3, several pins 4, and several long beads 5.

The shell 1 has an inner holding room, a first open end, and a second blocked end; the second blocked end is partially blocked with an inner annular protrusion (not numbered), and has a central lock hole 11. The shell 1 has three passage gaps 12 around the central lock hole 11 thereof; the number of the passage gaps 12 should be at least two, and is preferably three.

The annular holding member 2 has a central shaft 21 joined thereon, which has first and second ends sticking out from two ends of the annular holding member 2 respectively. The annular holding member 2 has three receiving gaps 22 to face the passage gaps 12 of the shell 1 respectively. The annular holding member 2 has several pin holding holes 23 around the central shaft 21. The first end of the central shaft 21 is held in the central lock hole 11 of the second end of the shell 1. Furthermore, the pins 4 are held in the pin holding holes 23 of the annular holding member 2 respectively.

The bead holder 3 has a receiving hole 31 in a middle portion to hold the second end of the central shaft 21 of the annular holding member 2. The bead holder 3 has several bead holding cavities 32 around the middle receiving hole 31 to face the pin holding holes 23 of the annular holding member 2. Elastic elements (springs) 6 are held in the bead holding cavities 32 respectively, and the long beads 5 are partially held in the bead holding cavities 32 to contact outward ends of the elastic elements 6 respectively.

The key (b) has several insertion bar portions (b1) on an outer side to be passed through respective ones of the passage gaps 12 of the shell 1 of the tubular lock (a).

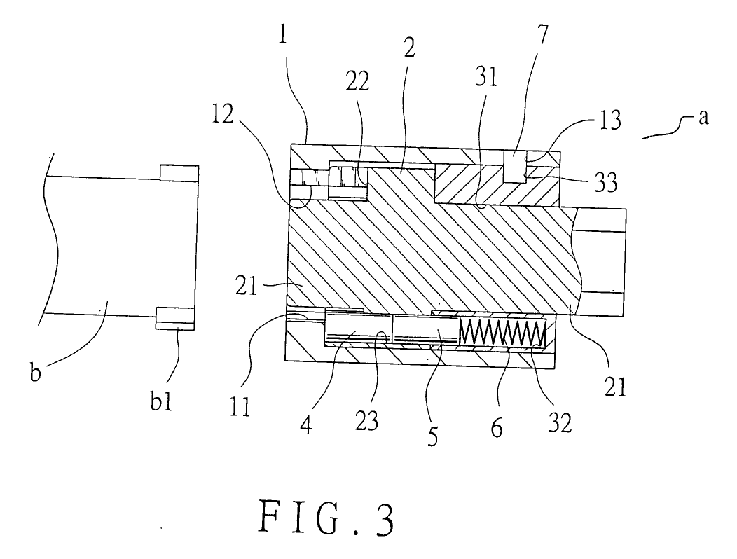

In assembly, referring to FIGS. 2 and 3, first the second end of the central shaft 21 of the annular holding member 2 is positioned in the middle receiving hole 31 of the bead holder 3 with the pin holding holes 23 facing the bead holding cavities 32 respectively. Next, the elastic elements 6 and the long beads 5 are passed into the bead holding cavities 32 of the bead holder 3 through the pin holding holes 23 of the annular holding member 2, and next the pins 4 are passed into the pin holding holes 23 so that the elastic elements 6 normally make the long beads 5 pass into the pin holding holes 23 so as to prevent the annular holding member 2 from turning relative to the bead holder 3. Then, the annular holding member 2 together with the bead holder 3 are positioned in the inner holding room of the shell 1 with the first end of the central shaft 21 being held in the lock hole 11 of the shell 1, and with the receiving gaps 22 of the annular holding member 2 facing the passage gaps 12 of the shell 1 respectively. Finally, a fixing pin 7 is inserted in a fixing hole 13 of the shell 1 as well as a fixing hole 33 of the bead holder 3 to fasten the bead holder 3 and the shell 1 together. Therefore, the pins 4 are normally forced to be in partial contact with the inner annular protrusion of the partially blocked second end of the shell 1 with other portions thereof facing outside through the lock hole 11 of the shell 1 by means of the elastic elements 6.

FIG. 3 is a sectional view the tubular lock (a) of the present invention, which is taken before the key (b) is inserted in the lock hole 11; in this case, the long beads 5 are partially held in the pin holding holes 23 of the annular holding member 2, and partially held in the bead holding cavities 32 of the bead holder 3 so that the annular holding member 2 is fixed in position, and prevented from turning relative to the bead holder 3 and the shell 1.

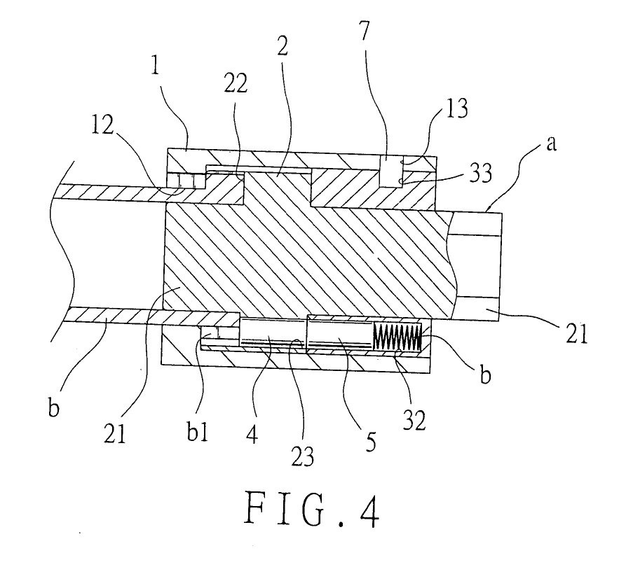

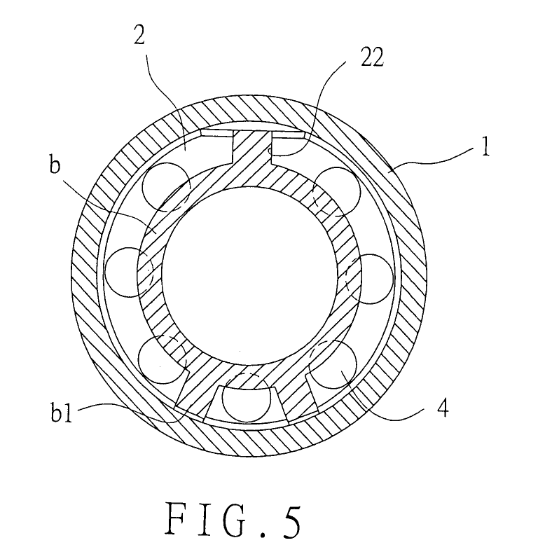

Shown in FIGS. 4 and 5 is the tubular lock (a) being moved between a locking configuration and an open one with the key (b). After the key (b) has been inserted in the key hole 11 of the tubular lock (a) with the insertion bar portions (b1) being passed into respective ones of the passage gaps 12 of the shell 1, the key (b) should be pressed further into the shell 11 so that the key (b) forces the pins 4 to move towards the bead holder 3, and the insertion bar portions (b1) of the key (b) are received in the receiving gaps 22 of the annular holding member 2 respectively; thus, the elastic elements 6 are compressed, and the long beads 5 are moved out of the pin holding holes 23 of the annular holding member 2 to no longer fix the annular holding member 2. Therefore, the annular holding member 2 is free to turn, and the user is allowed to turn the central shaft 21 with the key (b) to change the tubular lock (a) between a locking configuration and an open one.

Because there are at least two receiving gaps 22 on the annular holding member 2, force can be uniformly applied to the annular holding member 2 when the key (b) is being operated. Consequently, the annular holding member 2 will turn relatively smoothly. In other words, the tubular lock (a) is convenient to use.

Because the annular holding member 2 has at least two receiving gaps 22, all of the pin, long bead and elastic element combinations 4, 5, and 6 will be subjected to the same amount of force to move the same distance after the key (b) is pressed into the lock (a). Therefore, there won't be the risk of some of the long beads 5 being not completely disengaged from the annular holding member 2 when the key (b) is operated. Consequently, the long beads 5 are prevented from causing the annular holding member 2 to wear and get damaged.

Furthermore, because there are at least two passage gaps 12 on the shell 1, and the same number of receiving gaps 22 on the annular holding member 2 as well as the same number of insertion bar portions (b1) on the key (b), when the key (b) is being passed into the tubular lock (a), it has to be held in such a position that its axis is co-linear with the axis of the lock hole 11, otherwise it can't be pressed into the lock hole 11 with its insertion bar portions (b1) being received in the receiving gaps 22 of the annular holding member 2. Therefore, there can't be the risk of the key (b) and the tubular lock (a) causing damage to each other in operating the key (b).

From the above description, it can be seen that the present invention has the following advantages:

1. When the key is pressed into the lock and turned, force will be uniformly applied to the annular holding member. Consequently, the annular holding member will turn relatively smoothly.

2. All of the several pin, long bead and elastic element combinations will be subjected to the same amount of force to move the same distance after the key is pressed into the lock. Therefore, there won't be the risk of some of the long beads being not completely moved out of the pin holding holes of the annular holding member to cause damage to the annular holding member when the key is turned.

3. When the key is being passed into the tubular lock, it has to be held in such a position that its axis is co-linear with the axis of the lock hole, otherwise it can't be pressed into the lock hole for its insertion bar portions to be received in the receiving gaps of the annular holding member. Therefore, there can't be the risk of the key and the tubular lock causing damage to each other.

What is claimed is:

1. A tubular lock structure, comprising
a hollow shell, the shell having a first open end, and a second partially blocked end; the second end of the shell having a central lock hole; the shell having at least two passage gaps around the central lock hole thereof;
an annular holding member held in the shell, the annular holding member having a central shaft joined thereon; the central shaft having first and second ends sticking out from two ends of the annular holding member respectively; the annular holding member having a plurality of receiving gaps to face the passage gaps of the shell; the annular holding member having a plurality of pin holding holes around the central shaft; the first end of the central shaft being held in the central lock hole of the second end of the shell;
a plurality of pins, which are held in the pin holding holes of the annular holding member respectively;
a bead holder positioned around the second end of the central shaft of the annular holding member and held in the shell; the bead holder having a middle receiving hole, in which the second end of the central shaft is held; the bead holder having a plurality of bead holding cavities around the middle receiving hole to face the pin holding holes of the annular holding member;
a plurality of elastic elements, which are held in the bead holding cavities of the bead holder respectively; and
a plurality of long beads; each of the long beads being positioned between a corresponding said pin and an outward end of a corresponding said elastic element; the elastic elements biasing the long beads towards the pin holding holes of the annular holding member.

2. The tubular lock structure as claimed in claim 1, wherein a number of the passage gaps of the shell is three, and the receiving gaps of the annular holding member are as many as the passage gaps.

3. The tubular lock structure as claimed in claim 1, wherein each of the bead holder and the shell has a fixing hole, and the bead holder and the shell are fastened together with a fixing pin passed into the fixing holes thereof.

4. The tubular lock structure as claimed in claim 1, wherein the elastic elements are springs.

5. The tubular lock structure as claimed in claim 1 further comprising a key, which has a plurality of insertion bar portions thereon; the insertion bar portions being going to be passed through the passage gaps of the shell respectively when the key is inserted in the lock hole.
